(19) United States
(12) Patent Application Publication
(10) Pub. No.: US 2016/0292231 A1
(43) Pub. Date: Oct. 6, 2016

(54) CHANGE TRACKING FOR STRUCTURED LANGUAGES

(71) Applicant: International Business Machines Corporation, Armonk, NY (US)

(72) Inventors: Jojo Joseph, Bangalore (IN); NagaPraveena Palasamudram, Bangalore (IN)

(21) Appl. No.: 15/071,688

(22) Filed: Mar. 16, 2016

Related U.S. Application Data
(63) Continuation of application No. 14/672,394, filed on Mar. 30, 2015.

(51) Int. Cl. G06F 17/30; G06F 3/0484; G06F 3/0481; G06F 17/21; G06F 17/22

(52) U.S. Cl. CPC G06F 17/30525; G06F 17/30554; G06F 17/30368; G06F 17/30551; G06F 17/30911; G06F 17/218; G06F 17/2247; G06F 3/0481; G06F 3/0484

(57) ABSTRACT

Change tracking for a structured language document is provided. A first interaction indicating a change to an entity represented by a structured language document is received, wherein the change modifies a portion of prior content of the entity to a portion of new content. The portion of prior content to a change history is stored, wherein the change history is associated with the entity. The entity and the portion of new content is presented via a user interface. In response to receiving a second interaction with the user interface, a presentation of the entity is modified based, at least in part, on an ordering of one or more changes of the change history associated with the entity.

### BACKGROUND OF THE INVENTION

The present invention relates generally to the field of structured languages, and more particularly to tracking changes made to user interface elements in programs utilizing structured languages.

Enterprise application software is purpose-designed computer software used to satisfy the needs of an organization. Services provided by enterprise software are often business oriented tools. Enterprise application software functions as a way to track and view data used in many areas of business.

Extensible Markup Language (XML) is a structured language used in computer programming. XML is a language that defines a set of rules for encoding documents in a format readable by both humans and computers. XML, among other structured languages, is used in enterprise application software to store data relating to various entities within the enterprise application software.

Enterprise application software utilizes various entities in a graphical user interface (GUI). Often, the entities allow a user to input text or numerical data. Data entered can be stored to a structured language document, such as XML, or a database. The structured language document may contain other data (including an entity identifier (ID), a time stamp, and the identification of a user making the change) in addition to the entered data.

### SUMMARY

According to one embodiment of the present disclosure, a method for tracking changes is provided. The method includes receiving, by one or more processors, a first interaction indicating a change to an entity represented by a structured language document, wherein the change modifies a portion of prior content of the entity to a portion of new content; storing, by one or more processors, the portion of prior content to a change history, wherein the change history is associated with the entity; presenting, by one or more processors, the entity and the portion of new content via a user interface; and in response to receiving a second interaction with the user interface, modifying a presentation of the entity based, at least in part, on an ordering of one or more changes of the change history associated with the entity.

According to another embodiment of the present disclosure, a computer program product for change tracking is provided. The computer program product comprises a computer readable storage medium and program instructions stored on the computer readable storage medium. The program instructions include program instructions to receive a first interaction indicating a change to an entity represented by a structured language document, wherein the change modifies a portion of prior content of the entity to a portion of new content; program instructions to store the portion of prior content to a change history, wherein the change history is associated with the entity; program instructions to present the entity and the portion of new content via a user interface; and program instructions to in response to receiving a second interaction with the user interface, modify a presentation of the entity based, at least in part, on an ordering of one or more changes of the change history associated with the entity.

According to another embodiment of the present disclosure, a computer system for change tracking is provided. The computer system includes one or more computer processors, one or more computer readable storage media, and program instructions stored on the computer readable storage media for execution by at least one of the one or more processors. The program instructions include program instructions to receive a first interaction indicating a change to an entity represented by a structured language document, wherein the change modifies a portion of prior content of the entity to a portion of new content; program instructions to store the portion of prior content to a change history, wherein the change history is associated with the entity; program instructions to present the entity and the portion of new content via a user interface; and program instructions to in response to receiving a second interaction with the user interface, modify a presentation of the entity based, at least in part, on an ordering of one or more changes of the change history associated with the entity.

### BRIEF DESCRIPTION OF THE DRAWINGS

FIG. 1 is a functional block diagram illustrating a computing environment, in accordance with an embodiment of the present disclosure;

FIG. 2 is a flowchart depicting operations for storing content to an XML document, on a computing device within the computing environment of FIG. 1, in accordance with an embodiment of the present disclosure;

FIG. 3 is a flowchart depicting operations for change tracking, on a computing device within the computing environment of FIG. 1, in accordance with an embodiment of the present disclosure;

FIG. 4 is an example XML document presenting change tracking, in accordance with an embodiment of the present disclosure; and

FIG. 5 is a block diagram of components of a computing device executing operations for change tracking, in accordance with an embodiment of the present disclosure.

### DETAILED DESCRIPTION

An embodiment of the present invention recognizes that prior versions of entity data in an enterprise application program may be of interest to a user when a change is made to an entity within the program. An entity is an element of a user interface that can receive user input. For example, the entity can be a user editable abstract element in a web environment or an integrated development environment (e.g., web forms, user interface elements, etc.). Other examples of an entity include, but are not limited to, a configuration setting of an application, a Business Object, or a user interface coded in hypertext markup language (HTML). Data entered for entities within the enterprise application program is stored to a structured language document. Such data can be stored in any type of database. One of ordinary skill in the art will appreciate that a structured language document is discussed as an illustrative example of a repository storing the entity data. The structured language document can include, but is not limited to, formats such as such as XML, HTML, and cascading style sheets (CSS). In order to facilitate discussion, embodiments of the present invention are discussed herein using an XML document as an illustrative example, but it should be understood that XML is merely one example of a structured language document to which embodiments of the invention may apply. Without the ability to track changes made to entities in the enterprise application program, changes are tracked by manually comparing multiple versions of the XML document. The manual comparison is both time consuming and difficult for a user who is not familiar with the structure of the XML document. Further, such manual operations can be inaccurate and incomplete. For example, a user performing a manual comparison may be unable to generate precise timestamps or preserve entity IDs.

An embodiment of the present invention provides operations to view changes made to entities within an enterprise application program. Various embodiments of the present invention compile changes made to an entity of an enterprise application program, markup the entities that have changed, and display changes within the enterprise application program. Embodiments of the present invention provide a means of viewing the change history of entities within the enterprise application program.

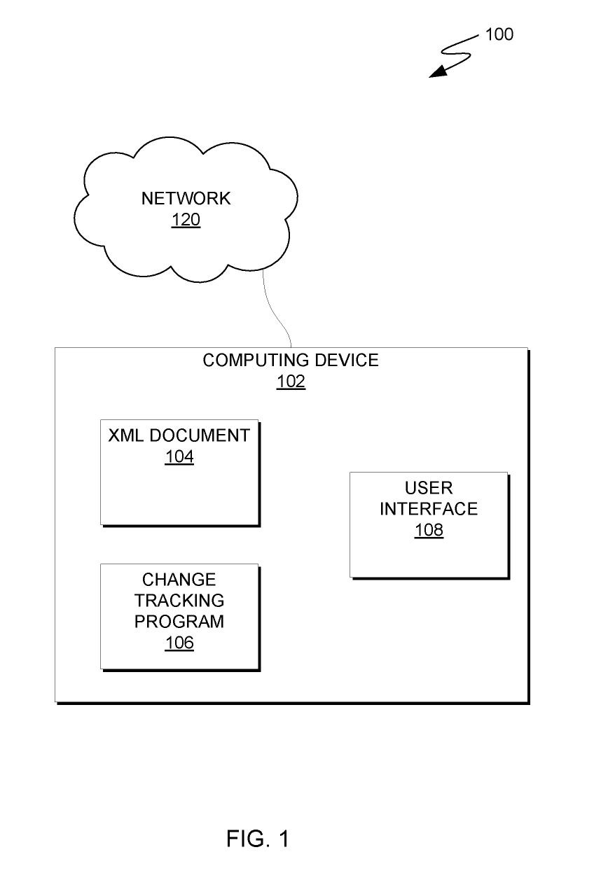

The present disclosure will now be described in detail with reference to the Figures. FIG. 1 is a functional block diagram illustrating a computing environment, in accordance with an embodiment of the present disclosure. For example, FIG. 1 is a functional block diagram illustrating computing environment 100. Computing environment 100 includes computing device 102 connected to network 120. Computing device 102 includes XML document 104, change tracking program 106, and user interface 108.

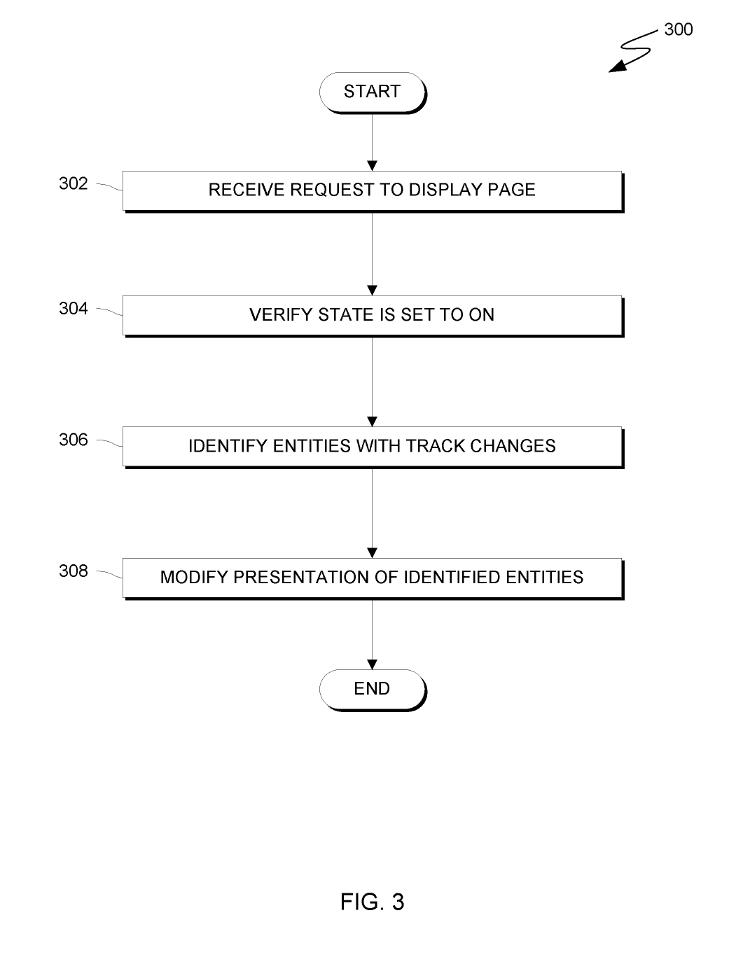

In various embodiments, computing device 102 is a computing device that can be a standalone device, a server, a laptop computer, a tablet computer, a netbook computer, a personal computer (PC), or a desktop computer. In another embodiment, computing device 102 represents a computing system utilizing clustered computers and components to act as a single pool of seamless resources. In general, computing device 102 can be any computing device or a combination of devices with access to and capable of executing change tracking program 106. Computing device 102 may include internal and external hardware components, as depicted and described in further detail with respect to FIG. 3.

In some embodiments, change tracking program 106 is stored on computing device 102. In other embodiments, change tracking program 106 may reside on another computing device, provided that change tracking program 106 can access and is accessible by XML document 104 and user interface 108. In yet other embodiments, XML document 104, change tracking program 106, and user interface 108 may be stored externally and accessed through a communication network, such as network 120. Network 120 can be, for example, a local area network (LAN), a wide area network (WAN) such as the Internet, or a combination of the two, and may include wired, wireless, fiber optic or any other connection known in the art. In general, network 120 can be any combination of connections and protocols that will support communications between computing device 102 and other computing devices, in accordance with a desired embodiment of the present invention.

Change tracking program 106 operates to track changes to XML document 104. In some embodiments, change tracking program 106 is a component of an enterprise program that operates to provide (e.g., via user interface 108) a visual representation of data (e.g., stored in XML document 104) related to the enterprise. In various embodiments, change tracking program 106 compiles a change history of an entity, modifies the manner in which an entity is presented via user interface 108, presents the changes to the entity with related change data (e.g., time stamp, a user ID of the user making the change, a computer ID of the computer from which the change was received, etc.), or a combination thereof.

XML document 104 is an example of a structured language document that stores data representing one or more entities. Each entity is represented by a portion of a structured language document corresponding to a user interface element that can be presented to a user via user interface 108. A user may modify (i.e., change) the content of an entity of XML document 104 by interaction with user interface 108. Each entity has a unique entity ID, which in some embodiments, does not change. The data stored to XML document 104 is associated with the unique entity ID, such that the stored data is available (e.g., to change tracking program 106, user interface 108, or both) based on the unique entity ID. In response to a user changing the data of an entity, change tracking program 106 stores the changed data to a change history of an XML document 104. A change history is associated with an entity of XML document 104 (e.g., via an entity ID of the entity). A change history may include one or more prior versions of entity data of an entity. In some embodiments, the change history of XML document 104 resides within XML document 104. For example, XML document 104 includes a current value of entity data and a change history associated with the entity that includes one or more prior values of the entity data. In other embodiments, the change history of XML document 104 resides in one or more change history documents separate from, but associated with, XML document 104. For example, in response to detecting a change to entity data of an entity, change tracking program 106 stores a previous value of the entity data to a change history residing within a change history document and a changed value of the entity data to XML document 104. In this case, the change history of the change history document is associated with the entity of XML document 104 that was changed. In one embodiment, a change history document includes one or more change histories for one or more entities. For example, a single change history document may include a change history for some or all of the entities of XML document 104. In another example, change tracking program 106 stores each change history in a separate change history document.

In some embodiments, XML document 104 stores data relevant to a particular business. For example, in a legal domain, XML document 104 may store information relevant to a legal case. In such an example, XML document 104 may store, for each case, the case name, client name, contact information, court dates, due dates, notices sent, reminders, etc. A user provides (e.g., via user interface 108) content for one or more such entities. However, the content entered may cease to be applicable, may change, or may have been entered incorrectly, or may otherwise need to be changed. Change tracking program 106 tracks the changes made to an entity of XML document 104.

In some embodiments, the functionality of change tracking program 106 to present tracked changes can be toggled between an on state and an off state. While change tracking program 106 is in the off state, user interface 108 presents XML document 104 without indicating the changes tracked by change tracking program 106. Changes made to entities within change tracking program 106 are recorded to XML document 104 when change tracking program 106 is in the off state, but are not presented in the user interface. While change tracking program 106 is in the on state, user interface 108 presents XML document 104 with one or more additional or modified user interface elements to provide the changes tracked by change tracking program 106. For example, an administrator using an enterprise program sets change tracking program 106 to the on state in order to view prior entries made for an entity of XML document 104. In one embodiment, whether change tracking program 106 displays changes and markup is selectively available based on access restrictions. For example, an administrator of an enterprise program provides access restrictions that control what changes other users are able to view. In one such example, the access restrictions can restrict a user's access to viewing changes to particular entities. In another such example, the access restrictions can restrict a user from viewing the identity of another user who has made changes to an entity. In yet other examples, the access restrictions can control access based on age of the change (e.g., when the change was made), content of the change (e.g., subject matter of an entity), a user who made the changes, a user attempting to access the changes, etc.

Computing device 102 includes user interface 108, which, in some embodiments, executes locally on computing device 102 and operates to provide a user interface to a user of computing device 102. In other embodiments, user interface 108 executes on another computing device in computing environment 100. In some embodiments, user interface 108 includes a graphical user interface (GUI), upon which a user can view the entries and changes of XML document 104. User interface 108 further operates to receive user input from a user via the provided user interface, thereby enabling the user to interact with computing device 102. In one embodiment, user interface 108 provides a user interface that enables a user of computing device 102 to interact with one or both of XML document 104 and change tracking program 106 of computing device 102. In various examples, the user interacts with change tracking program 106 in order to make and display changes to entities of XML document 104. In another example, the user interacts with change tracking program 106 in order to configure change tracking program 106, provide or modify access restrictions of change tracking program 106, or set change tracking program 106 to the on state or the off state. In one embodiment, user interface 108 is stored on computing device 102. In other embodiments, user interface 108 is stored on another computing device (e.g., computing device 102), provided that user interface 108 can access and is accessible by at least change tracking program 106.

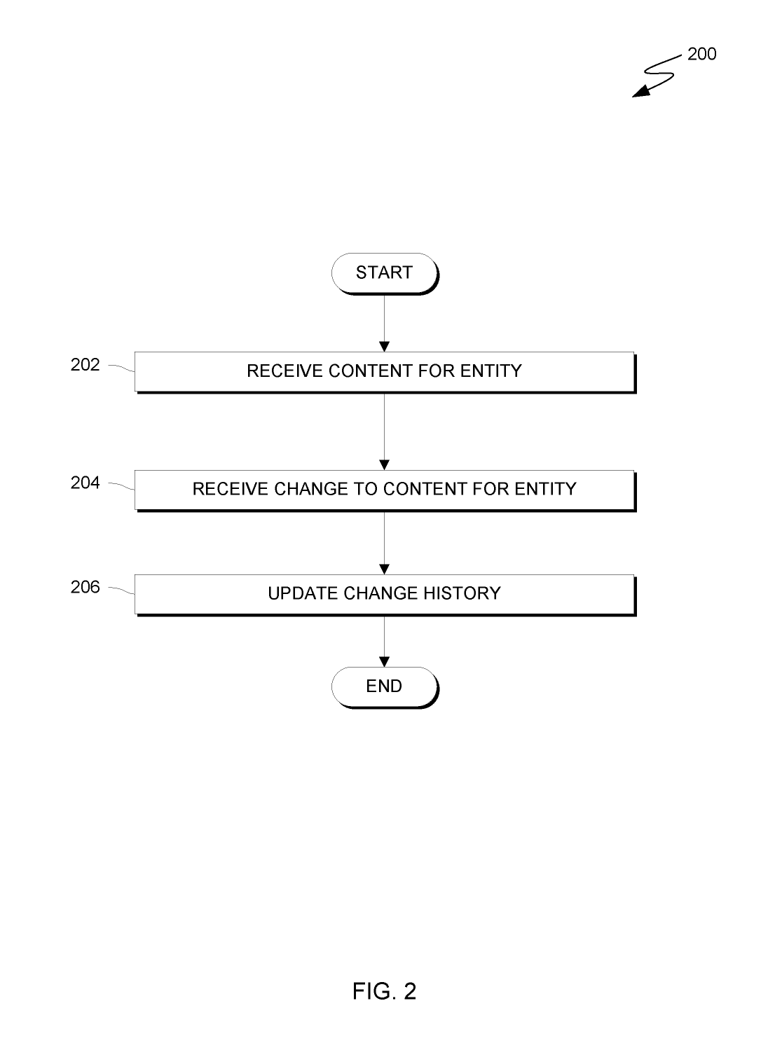

FIG. 2 is a flowchart depicting operations for storing content to an XML document, on a computing device within the computing environment of FIG. 1, in accordance with an embodiment of the present disclosure. For example, FIG. 2 is a flowchart depicting operations 200 of change tracking program 106, on computing device 102 within computing environment 100.

In step 202, change tracking program 106 receives content for an entity. A user interface displays entities of change tracking program 106. Each entity can receive content. Content can include, but is not limited to, text and files. For example, an entity of change tracking program 106 allows a user to upload a file (e.g., a document stored on computing device 102) which allows change tracking program 106 to display the contents of file in the user interface. The content is stored to XML document 104. For example, the file is stored to XML document 104 allowing change tracking program 106 to recall the document at a later time. In addition to storing the content, change tracking program 106 also stores characteristics related to the original content. Some of the characteristics include a unique entity ID, a user ID, a time stamp, etc. The unique entity ID associates the content to a specific entity within XML document 104, such that the content can be recalled to the entity after the initial user input.

In step 204, change tracking program 106 receives a change to the content for an entity, referred to as new content. In some embodiments, a user modifies the content of an entity. The new content is stored to XML document 104 along with characteristics related to the new content, including the unique entity ID. For example, change tracking program 106 is used in a legal services business. In this example, change tracking program 106 has multiple entities displayed on a user interface, among the entities is an entity that tracks a court date. A user inputs the initial court date of March 1. Change tracking program 106 receives this content (step 202) and stores it to XML document 104. After the content is recorded, the court date is postponed to April 15. In response, a user inputs the new date into the court date entity. Change tracking program 106 receives the new content and records the new content to XML document 104.

In step 206, change tracking program 106 updates the change history of XML document 104. In response to the content of an entity being changed, change tracking program 106 removes the prior entered content, writes the prior entered content to the change history of XML document 104, and writes the new content to the entity. In some embodiments, the change history is recorded as a previous value. When prior entered content is written to the change history, the associated content characteristics are written to the prior history.

In one embodiment, the change history resides in one or more change history documents, as discussed previously. For example, change tracking program 106 creates a change history document containing the change history of an entity in response to a change to the entity data of the entity. In this case, the change history document is updated with a prior version of the entity data and XML document 104 is updated with the new version of the entity data. For example, the entity data of an entity of XML document 104 is changed six times from an initial value, so there will be six prior versions of the entity data in the change history associated with the entity. Each of the six prior versions is associated with the entity ID of the entity. In another embodiment, the change history resides in XML document 104. In this embodiment, the change history is identified by an XML tag (e.g., change history tag 410). Further, the change history, and each prior version thereof, is associated with the entity ID of the entity that changed. For example, the change history of an entity is stored to XML document 104 and is associated with the entity ID of the entity.

In some embodiments, the prior added content is accompanied by an entity history ID that identifies content of prior added content. In these embodiments, the content will be written with the unique entity ID, the entity history ID, or both. For example, an entity of change tracking program 106 is changed six times. In this example, change tracking program 106 stores the new content and associated unique entity ID as content for the entity within XML document 104; and, XML document 104 stores the five prior content entries and associated entity history IDs for each of the five prior added content entries of the entity. In other embodiments, the prior added content is accompanied by the unique entity ID and a timestamp. In these embodiments, change tracking program 106 uses the timestamp to determine the most current content entry and an order (e.g., chronological order) of prior added content.

FIG. 3 is a flowchart depicting operations for change tracking, on a computing device within the computing environment of FIG. 1, in accordance with an embodiment of the present disclosure. For example, FIG. 3 is a flowchart depicting operations 300 of change tracking program 106, on computing device 102 within computing environment 100.

In step 302, change tracking program 106 receives a request to display a page. In some embodiments, the request is a user interaction with the GUI. In some embodiments, change tracking program 106 includes one or more pages, where each page has one or more entities. A user requests a page of change tracking program 106 via the GUI. In some embodiments, a page displays an entity and the received content (most current content) for the entity on the GUI. In other embodiments, the page displays the entity and a button in the GUI that links to the received content. In yet other embodiments, the page displays the entity, the received content, and the change history for the entity.

In step 304, change tracking program 106 verifies the state is set to on. In some embodiments, the track changes within the user interface can be turned on or off. For example, where change tracking program 106 has a user interface displaying a form with multiple entities the change tracking can be turned to off for ease of viewing the form. Change tracking program 106 in off state records changes made to entities, but does not present the changes in user interface 108. Change tracking program 106 with a state set to on both records changes made to entities and presents the changes in user interface 108. In some embodiments, the change tracking defaults to a state set to off. In these embodiments, a user changes the state to on through an interaction with the user interface. When the state of the change tracking is set to off, the change history of an entity cannot be viewed. In some embodiments, an administrator is able to control the state of the change tracking. For example, to manage which users have access to the change history, an administrator can disable (set state to off) for some users.

In step 306, change tracking program 106 identifies entities with track changes. Change tracking program 106 parses XML document 104 to find all content entries for an entity. In embodiments in which changes are stored in one or more versions of XML document 104, change tracking program 106 parses each version of XML document 104 for changes to the content of the entity. Change tracking program 106 aggregates each of the content entries for the entity, such that all of the entries can be displayed together. In embodiments in which changes are stored to a change history within a single version of XML document 104, change tracking program 106 retrieves the change history for the entity from XML document 104 based on the unique entity ID of the entity.

Change tracking program 106 orders the content entries for each entity identified to have track changes. In some embodiments, the ordering of changed entities is arranged in chronological order. In some embodiments, change tracking program 106 uses the time stamp associated with a content entry to determine the ordering The ordering is used to display the changes made to the content of an entity in a manner readable by the user. For example, change tracking program 106 displays change history of an entity in reverse chronological order, where the more recent content of the entity is displayed first and the oldest content is displayed last.

In step 308, change tracking program 106 modifies the presentation of identified entities within user interface 108. For example, change tracking program 106 modifies the presentation of an entity by adding markup to the entity within user interface 108. The markup indicates that a change history exists for the entity. Such markup can include, but is not limited to, highlighting, bolding, underlining, strikethrough, or italicizing some or all of the entity. In some embodiments, only a header associated with an entity is marked up. For example, the word “date” is displayed in bold and highlighted, but the entry “May 9” is displayed without markup. In other examples, all of the entity is marked up, including the entry. For example, both the word “data” and the entry “May 9” are displayed in bold and highlighted. In some embodiments, the markup displays the current and past entries for the entity. In other embodiments, a user accesses the history through a menu option on a GUI.

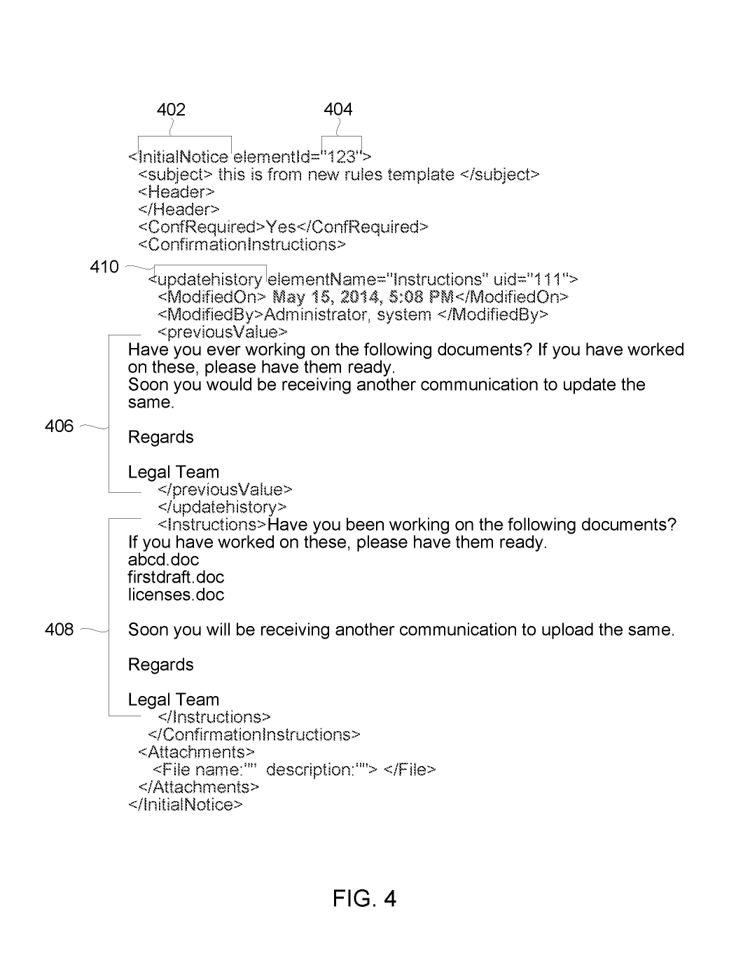

FIG. 4 is an example XML document presenting change tracking, in accordance with an embodiment of the present disclosure. For example, FIG. 4 depicts data stored to XML document 104, on computing device 102 within computing environment 100, through operations 200.

FIG. 4 includes entity 402, unique entity ID 404, prior value 406, new value 408, and change history tag 410. Entity 402 is the portion of change tracking program 106 that displays in user interface 108 and is able to receive an interaction from a user of change tracking program 106. For example, a user of change tracking program 106 will view “Initial Notice” in the user interface of change tracking program 106. The user is able to add content related to “Initial Notice” via an interaction with the user interface. Unique entity ID 404 associates content with the entity. For example, content added to entity 402 called “Initial Notice” will include the unique entity ID 404 of “123.” Unique entity ID 404 allows change tracking program 106 to recall the content of entity 402 by parsing XML document 104 for unique entity ID 404. By parsing XML document 104, change tracking program 106 knows to associate and display content with unique entity ID 404 with entity 402 in user interface 108.

In some embodiments, XML document 104 includes prior value 406 and new value 408. Prior value 406 corresponds to prior added content, such as content added during step 202 of FIG. 2. New value 408 corresponds to new content, such as content added during step 204 of FIG. 2. XML document 104 includes zero or more entries for prior value 406. In some embodiments, prior added content is identified within XML document 104 by change history tag 410. Change history tag 410 corresponds to step 206 of FIG. 2, where the change history of an entity is written to XML document 104.

In some embodiments, a new XML document (i.e., a change history document) is created to contain the change history for each entity of XML document 104. For example prior value 406 is stored to the change history document and new value 408 is stored to XML document 104. New value 408 is the most current content entry for an entity of change tracking program 106. Prior value 406 is part of the change history of an entity of change tracking program 106. In some embodiments, more than one prior value 406 will exist for each entity. In this case, each prior value 406 of an entity is stored to the change history document, and each prior value 406 is associated with the unique entity ID of the entity. In one embodiment, zero instances of prior value 406 exist for an entity. For example, zero instances of prior value 406 exist for an entity for which a change has not been received.

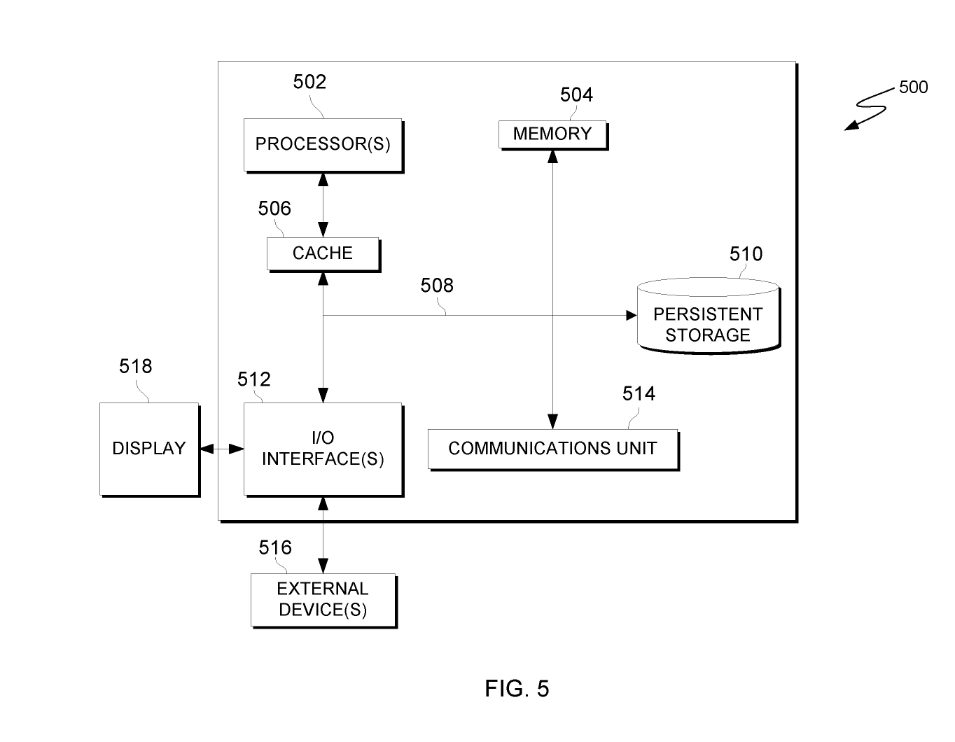

FIG. 5 is a block diagram of components of a computing device, generally designated 500, in accordance with an embodiment of the present disclosure. In one embodiment, computing device 500 is representative of computing device 102. For example, FIG. 5 is a block diagram of computing device 102 within computing environment 100 executing operations of change tracking program 106.

It should be appreciated that FIG. 5 provides only an illustration of one implementation and does not imply any limitations with regard to the environments in which different embodiments may be implemented. Many modifications to the depicted environment may be made.

Computing device 500 includes communications fabric 508, which provides communications between computer processor(s) 502, memory 504, cache 506, persistent storage 510, communications unit 514, and input/output (I/O) interface(s) 512. Communications fabric 508 can be implemented with any architecture designed for passing data and/or control information between processors (such as microprocessors, communications and network processors, etc.), system memory, peripheral devices, and any other hardware components within a system. For example, communications fabric 508 can be implemented with one or more buses.

Memory 504 and persistent storage 510 are computer-readable storage media. In this embodiment, memory 504 includes random access memory (RAM). In general, memory 504 can include any suitable volatile or non-volatile computer readable storage media. Cache 506 is a fast memory that enhances the performance of processors 502 by holding recently accessed data, and data near recently accessed data, from memory 504.

Program instructions and data used to practice embodiments of the present invention may be stored in persistent storage 510 and in memory 504 for execution by one or more of the respective processors 502 via cache 506. In an embodiment, persistent storage 510 includes a magnetic hard disk drive. Alternatively, or in addition to a magnetic hard disk drive, persistent storage 510 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 510 may also be removable. For example, a removable hard drive may be used for persistent storage 510. Other examples include optical and magnetic disks, thumb drives, and smart cards that are inserted into a drive for transfer onto another computer-readable storage medium that is also part of persistent storage 510.

Communications unit 514, in these examples, provides for communications with other data processing systems or devices, including resources of network 120. In these examples, communications unit 514 includes one or more network interface cards. Communications unit 514 may provide communications through the use of either or both physical and wireless communications links. Program instructions and data used to practice embodiments of the present invention may be downloaded to persistent storage 510 through communications unit 514.

I/O interface(s) 512 allows for input and output of data with other devices that may be connected to computing device 500. For example, I/O interface 512 may provide a connection to external devices 516 such as a keyboard, keypad, a touch screen, and/or some other suitable input device. External devices 516 can also include portable computer-readable storage media such as, for example, thumb drives, portable optical or magnetic disks, and memory cards. Software and data used to practice embodiments of the present invention (e.g., software and data) can be stored on such portable computer-readable storage media and can be loaded onto persistent storage 510 via I/O interface(s) 512. I/O interface(s) 512 also connect to a display 518.

Display 518 provides a mechanism to display data to a user and may be, for example, a computer monitor, or a television screen.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method comprising:
receiving, by one or more processors, a first interaction indicating a change to an entity represented by a structured language document, wherein the change modifies a portion of prior content of the entity to a portion of new content;
storing, by one or more processors, the portion of prior content to a change history, wherein the change history is associated with the entity;
presenting, by one or more processors, the entity and the portion of new content via a user interface; and
in response to receiving a second interaction with the user interface, modifying a presentation of the entity based, at least in part, on an ordering of one or more changes of the change history associated with the entity.

2. The method of claim 1, wherein the portion of new content includes text and wherein the change is associated with one or more of i) a unique entity ID, ii) a user ID, iii) a timestamp, and iv) a computer ID.

3. The method of claim 1, modifying the presentation of the entity further comprises adding a markup to the entity, wherein the markup modifies the presentation of some or all of the entity.

4. The method of claim 3, wherein the markup modifies a presentation of the portion of new content utilizing one or more of i) bold, ii) italicizing, iii) underlining, iv) strikethrough, and v) highlighting.

5. The method of claim 1, wherein the ordering is a reverse chronological ordering.

6. The method of claim 1, wherein modifying the presentation of the entity further comprises:
presenting, by one or more processors, the one or more changes via the user interface selectively, based, at least in part, on access restrictions that control access of a user to view the one or more changes.

7. The method of claim 1, wherein the change history is stored to the structured language document.
